(19) United States
(12) Patent Application Publication
(10) Pub. No.: US 2007/0162692 A1
(43) Pub. Date: Jul. 12, 2007

(54) Power controlled disk array system using log storage area

(76) Inventors: Akira Nishimoto, Sagamihara (JP); Naoto Matsunami, Hayama (JP); Yoichi Mizuno, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/355,010

(22) Filed: Feb. 16, 2006

(30) Foreign Application Priority Data
Dec. 1, 2005 (JP) 2005-347595

(51) Int. Cl. G06F 13/00; G06F 1/32; G06F 12/16

(52) U.S. Cl. 711/113; 713/320; 711/114

(57) ABSTRACT

Power consumption of a storage system is reduced by shutting down disk drives when they are not needed. A storage system having an interface connected to a host computer, a controller connected to the interface and having a processor and a memory, and disk drives storing data that is requested to be written by the host computer, comprises a log storage area to temporarily store data that is requested to write by a write request sent from the host computer and a plurality of data storage areas to store the data requested to write by the write request. The controller provides the data storage areas as a plurality of RAID groups constituted of the disk drives. The controller moves data from the log storage area to the data storage areas on a RAID group basis.

### CLAIM OF PRIORITY

The present application claims priority from Japanese patent application P2005-347595 filed on Dec. 1, 2005, the content of which is hereby incorporated by reference into this application.

### BACKGROUND

This invention relates to a storage system, and more specifically to a power control technique for a storage system.

The amount of data handled by a computer system is exponentially increasing in pace with the recent rapid development of information systems owing to deregulation on electronic preservation, expansion of Internet businesses, and computerization of procedures. Also, an increasing number of customers are demanding disk drive-to-disk drive data backup and long-term preservation of data stored in a disk drive, thereby prompting capacity expansion of storage systems.

This has encouraged enhancement of storage systems in business information systems. On the other hand, customers' expectation for a lower storage system management cost is building. Power-saving techniques for disk drives have been proposed as one of methods to cut the management cost of a large-scale storage system.

For example, US 2004/0054939 A discloses a technique of controlling power supply to disks in a RAID group individually. Specifically, with a RAID 4 stripe as one drive, a parity disk and only one disk for sequential write are activated. A powered-on disk drive which is kept operating all the time is provided and used as a buffer when a powered-off disk drive is accessed. The powered-on disk drive stores a copy of data header to read the data out of the powered-off disk drive.

JP 2000-293314 A discloses a technique of turning off the power of, or put into a power-saving state, disks in a RAID group that are not being accessed.

### SUMMARY

The above technique disclosed in US 2004/0054939 A is a technique fit for sequential write and is favorable for archiving, but not for normal online uses where random access is the major access method.

The technique disclosed in JP 2000-293314 A may not be very effective in online uses where a time period during which a disk drive is not accessed rarely exceeds a certain length.

Applying this technique to random access is not much better since IOPS per disk drive is small in some cases. For instance, in the case of 10 IOPS per disk drive, when a disk drive is operated for 10 milliseconds for one I/O, the disk drive is actually in operation for only 100 milliseconds out of one second, namely, 10%.

It is therefore an object of this invention to reduce the power consumption of a storage system by shutting down a disk drive while the disk drive is not needed.

According to a representative aspect of this invention, a storage system has: an interface connected to a host computer; a controller connected to the interface and having a processor and a memory; and disk drives storing data that is requested to be written by the host computer. The storage system comprises a log storage area for temporarily storing data that is requested to write by a write request sent from the host computer; and a plurality of data storage areas for storing the data requested to write by the write request. In the storage system, the controller provides the data storage areas as a plurality of RAID groups composed of the disk drives, and moves data from the log storage area to the data storage areas on the RAID group basis.

A disk array system according to an embodiment of this invention has normal drives, which are operated intermittently, and a log drive, which is kept operating all the time to store data requested by a write request from a host computer. To move data from the log drive to one of the normal drives, only disk drives that constitute a specific RAID group are operated, and data of the specific RAID group is picked out of the log drive and written in the normal drive that is in operation.

According to this invention, host data is stored in the log drive once, and then the stored data is moved from the log drive to the normal drives. This means that data is moved from the log drive to the normal drives concentratedly while the disk drives are in operation. Thus the normal drives can selectively be put into operation, and the operation time of a disk drive can be cut short.

### BRIEF DESCRIPTION OF THE DRAWINGS

The present invention can be appreciated by the description which follows in conjunction with the following figures, wherein:

FIG. 1 is a configuration diagram of a computer system according to a first embodiment of this invention;

FIG. 2 is a configuration diagram of disk drives in a disk array system according to the first embodiment of this invention;

FIG. 3 is a configuration diagram of a log control table according to the first embodiment of this invention;

FIG. 4 is a flow chart for host I/O reception processing according to the first embodiment of this invention;

FIG. 5 is a flow chart for processing of moving data from a log drive to a normal drive according to the first embodiment of this invention;

FIG. 6 is a configuration diagram of disk drives in a disk array system according to a second embodiment of this invention;

FIG. 7 is a configuration diagram of a log control table according to the second embodiment of this invention;

FIG. 8 is a configuration diagram of a cache memory and disk drives in a disk array system according to a third embodiment of this invention;

FIG. 9 is a configuration diagram of a disk cache segment management table according to the third embodiment of this invention;

FIG. 10 is a flow chart for host I/O reception processing in the disk array system according to the third embodiment of this invention;

FIG. 11 is a flow chart for processing of moving data from a disk cache to a normal drive in the disk array system according to the third embodiment of this invention; and

FIG. 12 is a flow chart for processing of moving data from the cache memory to the normal drive in the disk array system according to the third embodiment of this invention.

### DETAILED DESCRIPTION OF THE PREFERRED EMBODIMENT

Embodiments of this invention will be described below with reference to the accompanying drawings.

### First Embodiment

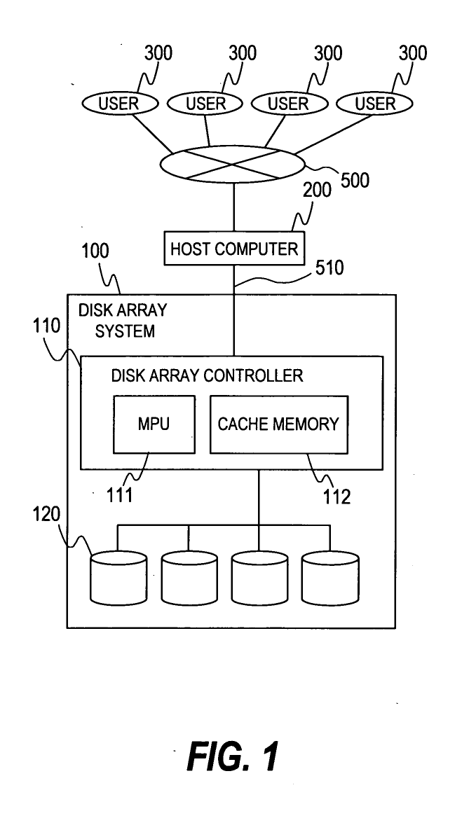

FIG. 1 is a configuration diagram of a computer system according to a first embodiment of this invention.

The computer system of the first embodiment has client computers 300, which are operated by users, a host computer 200, and a disk array system 100.

Each of the client computers 300 is connected to the host computer 200 via a network 500, over which Ethernet (registered trademark) data and the like can be communicated.

The host computer 200 and the disk array system 100 are connected to each other via a communication path 510. The communication path 510 is a network suitable for communications of large-capacity data. An SAN (Storage Area Network), which follows the FC (Fibre Channel) protocol for communications, or an IP-SAN, which follows the iSCSI (Internet SCSI) protocol for communications, is employed as the communication path 510.

The disk array system 100 has a disk array controller 110 and disk drives 120.

The disk array controller 110 has an MPU 111 and a cache memory 112. The disk array controller 110 also has a host interface, a system memory, and a disk interface, though not shown in the drawing.

The host interface communicates with the host computer 200. The MPU 111 controls the overall operation of the disk array system 100. The system memory stores control information and a control program which are used by the MPU 111 to control the disk array system 100.

The cache memory 112 temporarily keeps data inputted to and outputted from the disk drives 120. The disk drives 120 are non-volatile storage media, and store data used by the host computer 200. The disk interface communicates with the disk drives 120, and controls data input/output to and from the disk drives 120.

The MPU 111 executes the control program stored in the system memory, to thereby control the disk array system 100. The control program is normally stored in a non-volatile medium (not shown) such as a flash memory and, after the disk array system 100 is turned on, transferred to the system memory to be executed by the MPU 111. The control program may be kept in the disk drives 120 instead of a non-volatile memory.

The disk drives 120 in this embodiment constitute RAID (Redundant Array of Independent Disks) to give redundancy to stored data. In this way, loss of stored data from a failure in one of the disk drives 120 is avoided and the reliability of the disk array system 100 can be improved.

The host computer 200 is a computer having a processor, a memory, an interface, storage, an input device, and a display device, which are connected to one another via an internal bus. The host computer 200 executes, for example, a file system and provides the file system to the client computer 300.

The client computer 300 is computer having a processor, a memory, an interface, storage, an input device, and a display device, which are connected to one another via an internal bus. The client computer 300 executes, for example, application software and uses the file system provided by the host computer 200 to input/output data stored in the disk array system 100.

A management computer used by an administrator of this computer system to operate the disk array system 100 may be connected to the disk array system 100.

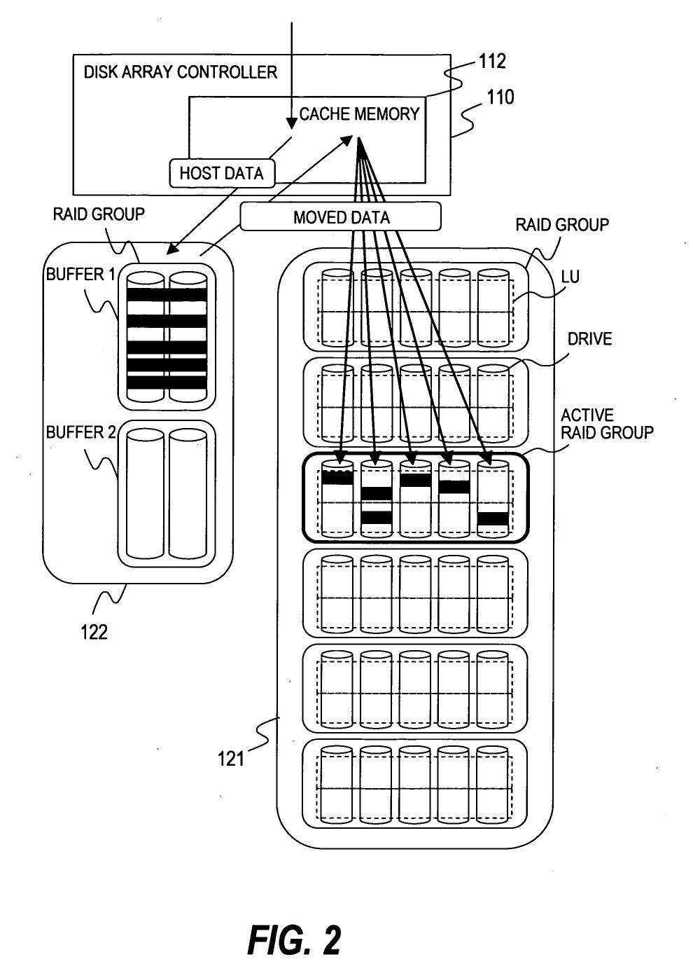

FIG. 2 is a configuration diagram of the disk drives 120 in the disk array system 100 according to the first embodiment.

The disk drives 120 include a normal drive 121 and a log drive 122.

In the normal drive 121, a plurality of disk drives constitute a plurality of RAID 5 groups. Although this embodiment employs RAID 5 groups, RAID groups of other RAID levels (RAID 1 or RAID 4) may be employed instead. The normal drive 121 is activated only when it is needed for data read/write, and therefore is operated intermittently.

The log drive 122 is a group of disk drives where host data sent from the host computer 200 is stored temporarily. The log drive 122 is always operated to make data read/write possible.

The log drive 122 constitutes a RAID 1 group. In other words, the log drive 122 provides a double-buffering configuration through mirroring by writing host data in two disk drives. The log drive 122 may constitute a RAID group of other RAID levels than RAID 1 (RAID 4 or RAID 5).

The log drive 122 has two RAID groups (a buffer 1 and a buffer 2). Host data sent from the host computer is written in the buffer 1 first. Once the buffer 1 is filled up, host data is written in the buffer 2.

The log drive 122, which, in this embodiment, has two RAID groups, may have three or more RAID groups. If the log drive 122 has three RAID groups, two of them can respectively serve as a first RAID group in which host data is written and a second RAID group out of which data is being moved to the normal drive 121 while the remaining one serves as an auxiliary third RAID group. Then, in the case where a temporary increase in amount of host data causes the first RAID group to fill up before processing of moving data out of the second RAID group is finished, host data can be written in the third RAID group. The response characteristics of the log drive 122 with respect to the host computer 200 can thus be improved.

The outline of host data storing operation will be described next.

Receiving a data write request from the host computer 200, the disk array controller 110 writes received host data in the log drive 122. To write data in the log drive 122, the data is written in the buffer 1 first. The buffer 1 is gradually filled with host data and, when the buffer 1 is filled up to its capacity, the disk array controller 110 writes host data in the buffer 2.

While host data is written in the buffer 2, the disk array controller 110 groups host data stored in the buffer 1 by RAID group of the normal drive 121, and moves each data group to a corresponding logical block of the normal drive 121.

Thereafter, when the buffer 2 is filled up with host data, the disk array controller 110 writes host data in the buffer 1, which has finished moving data out and is now empty.

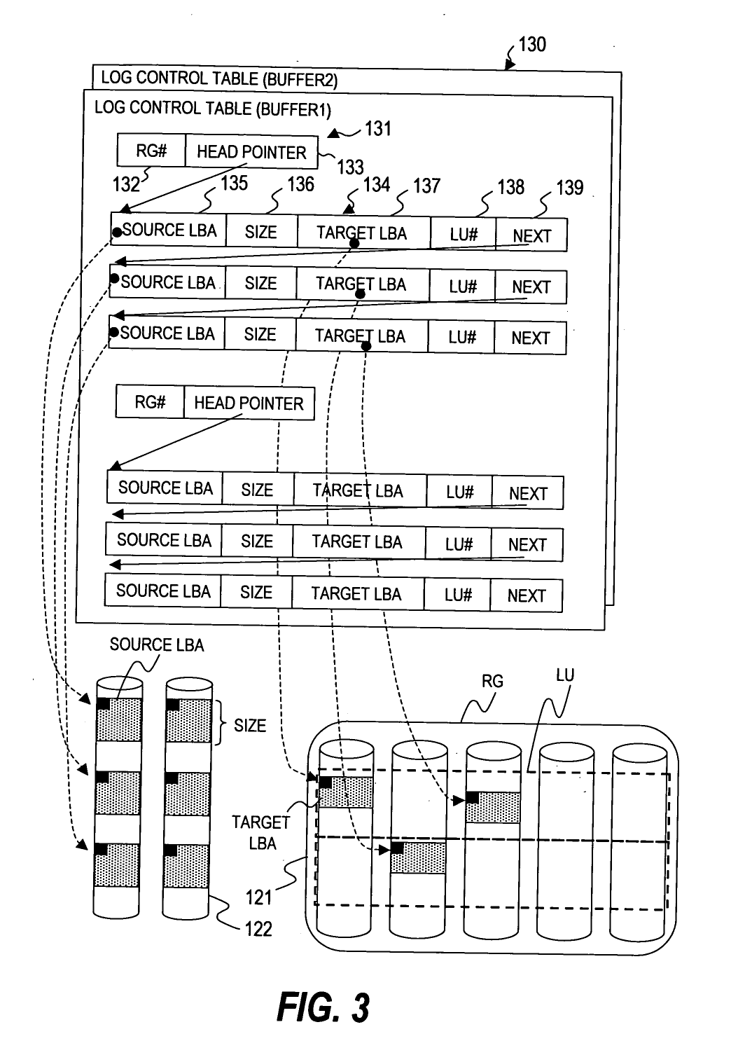

FIG. 3 is a configuration diagram of a log control table 130 according to the first embodiment.

The log control table 130 is prepared for each RAID group of the log drive 122, and is stored in the cache memory 112. Alternatively, data of the entire log drive 122 may be stored in one log control table 130 in a distinguishable manner.

The log control table 130 contains a plurality of RAID group number lists 131 each associated with a RAID group of the normal drive 121.

The RAID group number lists 131 have a linked-list format in which information on data stored in the log drive 122 is sorted by RAID group of the normal drive 121. The RAID group number lists 131 each contain a RAID group number 132, a head pointer 133, and an entry 134, which shows the association between LBAs.

The RAID group number 132 indicates an identifier unique to each RAID group in the normal drive 121. The head pointer 133 indicates, as information about a link to the first entry 134 of the RAID group identified by the RAID group number 132, the address in the cache memory 112 of the entry 134. When this RAID group has no entry 134, “NULL” is written as the head pointer 133.

Each entry 134 contains a source LBA 135, a size 136, a target LBA 137, a logical unit number 138, and link information 139, which is information about a link to the next entry.

The source LBA 135 indicates the address of a logical block in the log drive 122 that stores data. A logical block is a data write unit in the disk drives 120, and data is read and written on a logical block basis.

The size 136 indicates the magnitude of data stored in the log drive 122.

The target LBA 137 indicates an address that is contained in a data write request sent from the host computer 200 as the address of a logical block in the normal drive 121 that is where data stored in the log drive 122 is to be written.

The logical unit number 138 indicates an identifier that is contained in a data write request sent from the host computer 200 as an identifier unique to a logical unit in the normal drive 121 that is where data stored in the log drive 122 is to be written.

The link information 139 indicates, as a link to the next entry, an address in the cache memory 112 at which the next entry is stored. When there is no entry, “NULL” is written as the link information 139.

A block in the log drive 122 storing data is specified from the source LBA 135 and the size 136. A block in the normal drive 121 storing data is specified from the logical unit number 138, the target LBA 137, and the size 136.

Data to be stored in the normal drive 121 is first stored in the log drive 122 in this embodiment. Alternatively, a command to be executed in the normal drive 121 (for example, a transaction in a database system) may be stored in the log drive 122.

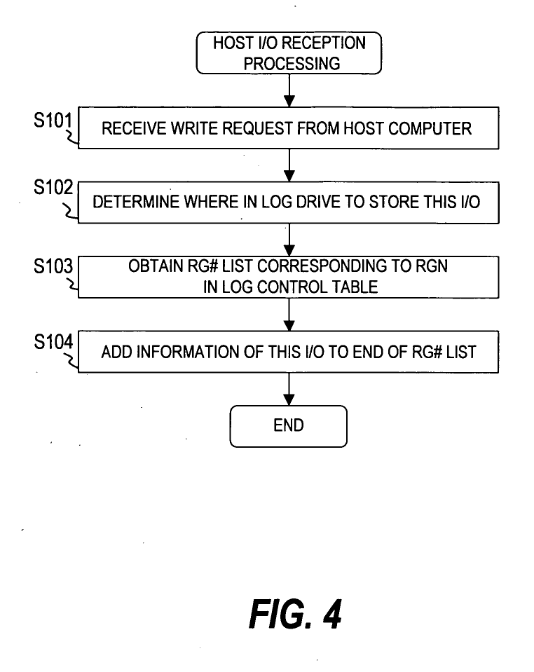

FIG. 4 is a flow chart for host I/O reception processing of the disk array system 100 according to the first embodiment. The host I/O reception processing is executed by the MPU 111 of the disk array controller 110.

First, a data write request is received from the host computer 200. The MPU 111 extracts from the received write request the logical unit number (LUN) of a logical unit in which data is requested to be written, the logical block number (target LBA) of a logical block in which the requested data is to be written, and the size of the data to be written. Then the MPU 111 identifies a number assigned to a RAID group to which the logical unit having the extracted logical unit number belongs (S101).

The MPU 111 then determines a position (source LBA) in the log drive 122 where the data requested to be written is stored (S102). Since write requests are stored in the log drive 122 in order, a logical unit that is next to the last logical unit where host data is stored is determined as the source LBA.

The MPU 111 next obtains the RAID group number list 131 that corresponds to the RAID group number identified in step S101. From the head pointer 133 of the obtained RAID group number list 131, the MPU 111 identifies a head address in the cache memory 112 at which the entry 134 of this RAID group is stored (S103).

Then the MPU 111 stores information of the write request in the RAID group number list 131. Specifically, the source LBA, target LBA, size, and logical unit number (LUN) according to the write request are added to the end of the RAID group number list 131 (S104).

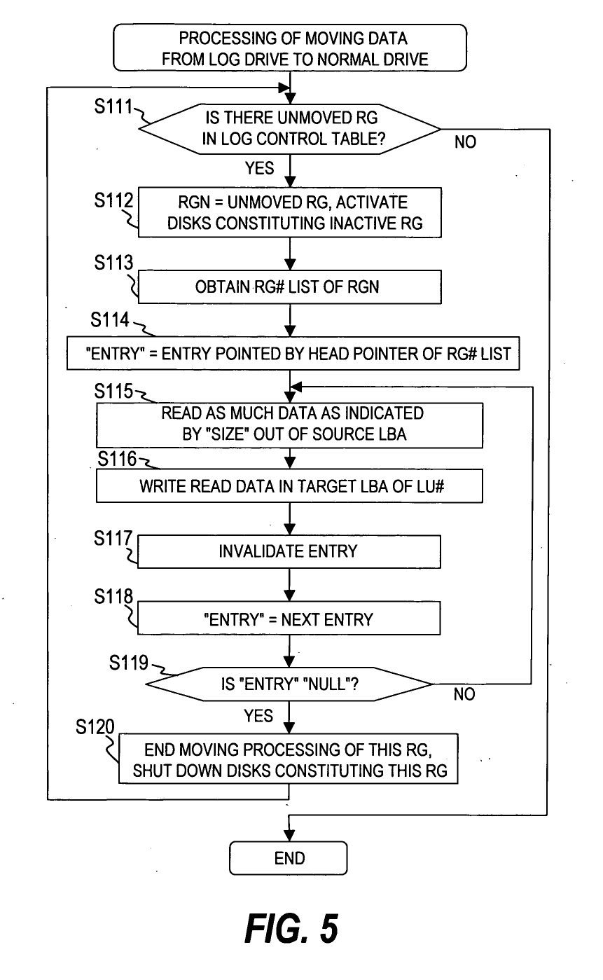

FIG. 5 is a flow chart for processing of moving data from the log drive 122 to the normal drive 121 in the disk array system 100 according to the first embodiment.

This data moving processing is executed by the MPU 111 of the disk array controller 110 once the buffer 1 is filled up, to thereby move data stored in the buffer 1 to the normal drive 121. The data moving processing is also executed when the buffer 2 is filled up, to thereby move data stored in the buffer 2 to the normal drive 121.

First, the MPU 111 judges whether or not an unmoved RAID group is found in the log control table 130 (S111). Specifically, the MPU 111 checks the head pointer 133 of each RAID group number list 131 and, when “NULL” is written as the head pointer 133, judges that data has been moved out of this RAID group.

In the case where it is judged as a result that data has been moved out of every RAID group, the moving processing is ended.

On the other hand, when there is a RAID group that has not finished moving data out, the processing moves to step S112.

In step S112, a number assigned to a RAID group that has not finished moving data out is set to RGN. Then the MPU 111 activates disk drives constituting the RAID group that has not finished moving data out.

In embodiments of this invention, disk drives constituting the normal drive 121 are usually kept shut down. A disk drive is regarded as shut down when a motor of the disk drive is stopped by operating the disk drive in a low power consumption mode, and when the motor and control circuit of the disk drive are both stopped by cutting power supply to the disk drive.

In other words, in step S112, power is supplied to the disk drives, and the operation mode of the disk drives are changed from the low power consumption mode to a normal operation mode to put motors and control circuits of the disk drives into operation.

Thereafter, the RAID group number list 131 that corresponds to the set RGN is obtained from the log control table 130 (S113).

Referring to the obtained RAID group number list 131, the MPU 111 sets the first entry that is pointed by the head pointer 133 to “Entry” (S114).

The entry set to “Entry” is referred to read, out of the log drive 122, as much data as indicated by the size 136 counted from the source LBA 135 (S115). The read data is written in an area in the normal drive 121 that is specified by the logical unit number 138 and the target LBA 137 (S116). This entry is then invalidated by removing it from the linked-list (S117).

Thereafter, the next entry is set to “Entry” (S118). The MPU 111 judges whether or not the set “Entry” is “NULL” or not (S119).

When it is found as a result that “Entry” is not “NULL”, it means that there is an entry next to the current entry, and the MPU 111 returns to step S115 to process the next entry.

On the other hand, when “Entry” is “NULL”, it means that there is no entry next to the current entry. The MPU 111 judges that the processing of moving data out of this RAID group has been completed, and shuts down disk drives that constitute this RAID group (S120). To be specific, motors of the disk drives are stopped by cutting power supply to the disk drives, or by changing the operation mode of the disk drives from the normal operation mode to the low power consumption mode.

The MPU 111 then returns to step S111 to judge whether there is an unmoved RAID group or not.

The disk array system 100 of the first embodiment responds to a data read request from the host computer 200 by first referring to the logical unit number 138 and the target LBA 137 in the log control table 130 to confirm whether data requested to be read is stored in the log drive 122.

In the case where the data requested to be read is in the log drive 122, the data stored in the log drive 122 is sent to the host computer 200 in response. In the case where the data requested to be read is not in the log drive 122, the data is read out of the normal drive 121 and sent to the host computer 200 in response.

As has been described, in the first embodiment of this invention, host data is stored in the log drive 122 once. Host data stored in the log drive 122 is grouped by RAID group of the normal drive 121 to be moved to the normal drive 121 on a RAID group basis. In this way, data is moved from the log drive 122 to the normal drive 121 concentratedly while the normal drive 121 is in operation. Thus the normal drive 121 can be put into operation intermittently, and the operation time of the normal drive 121 can be cut short.

Accordingly, effective power control of a disk drive is achieved for online data and other data alike.

Furthermore, in the first embodiment where host data is written in two RAID groups in turn, data can be written in the log drive 122 at the same time data is read out of the log drive 122. This enables the disk array system 100 to receive an I/O request from the host computer 200 while data is being moved to the normal drive 121, and the disk array system 100 is improved in response characteristics with respect to the host computer 200.

### Second Embodiment

A second embodiment of this invention will be described next.

The second embodiment differs from the first embodiment described above in terms of the configuration of the log drive 122. In the second embodiment, the same components as those in the first embodiment are denoted by the same reference symbols, and descriptions on such components will be omitted here.

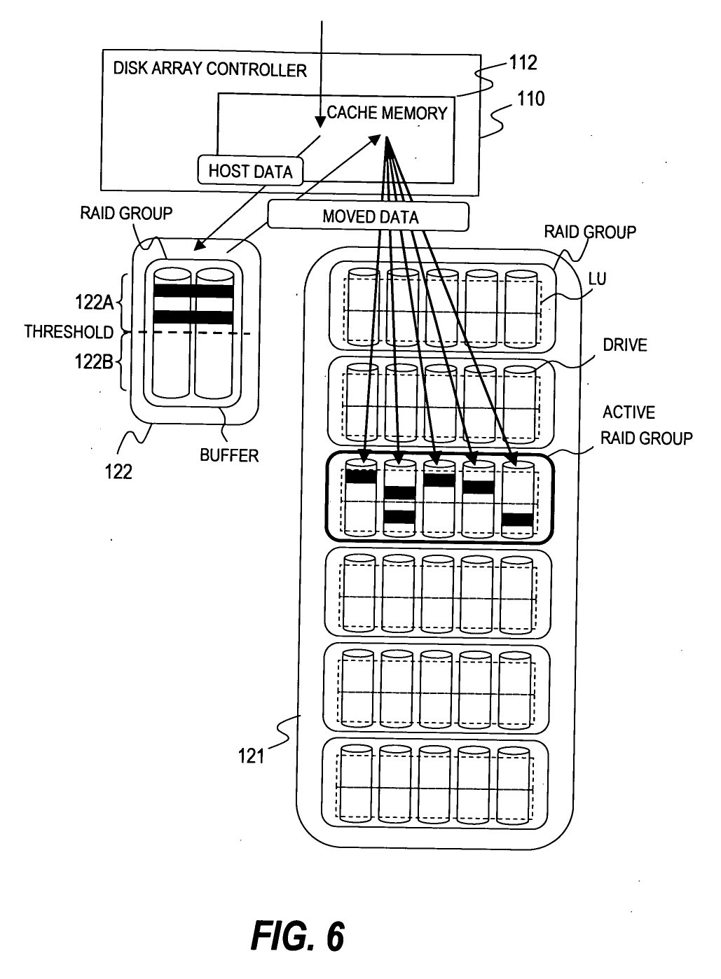

FIG. 6 is a configuration diagram of the disk drives 120 in the disk array system 100 according to the second embodiment.

The disk drives 120 include a normal drive 121 and a log drive 122.

The log drive 122 has one RAID group (a buffer).

The log drive 122 is a disk drive where host data sent from the host computer 200 is stored temporarily, and constitutes a RAID group of a RAID 1. The log drive 122 may constitute a RAID group of other RAID levels than RAID 1 (RAID 4 or RAID 5).

The outline of host data storing operation will be described next.

The disk array controller 110 receives a data write request from the host computer 200 and writes received host data in a first area 122A of the log drive 122. When the usage of the log drive 122 exceeds a certain threshold, it means that the first area 122A is full, and subsequent host data is written in a second area 122B of the log drive 122. At this point, the disk array controller 110 groups host data stored in the first area 122A by RAID group of the normal drive 121, and moves each data group to a corresponding logical block of the normal drive 121.

Thereafter, when the second area 122B is filled up with host data, the disk array controller 110 writes subsequent host data in the first area 122A while moving the host data stored in the second area 122B to the normal drive 121.

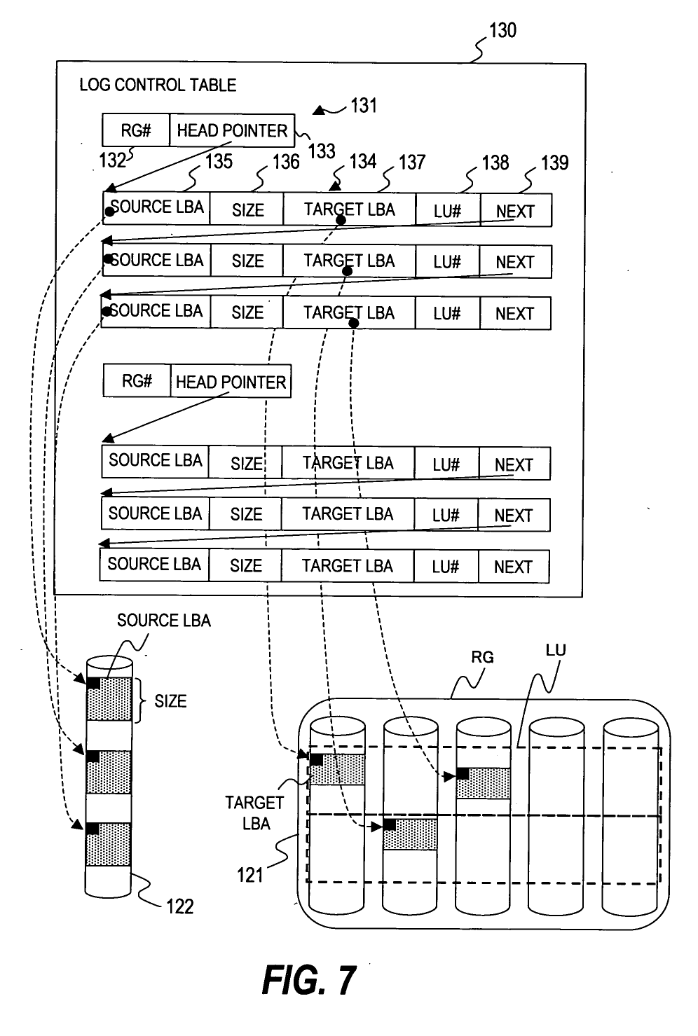

FIG. 7 is a configuration diagram of a log control table 130 according to the second embodiment.

The log control table 130 is prepared according to RAID group of the log drive 122.

The log control table 130 contains a plurality of RAID group number lists 131 each associated with a RAID group of the normal drive 121.

The RAID group number lists 131 are information used to identify a RAID group in the normal drive 121. The RAID group number lists 131 have a linked-list format, and each contain a RAID group number 132, a head pointer 133 and an entry 134, which shows the association between LBAs. Each entry 134 contains a source LBA 135, a size 136, a target LBA 137, a logical unit number 138 and link information 139, which is information about a link to the next entry.

Information stored in the log control table 130 of the second embodiment is the same as information stored in the log control table 130 of the first embodiment.

As has been described, in the second embodiment of this invention, data is moved from the log drive 122 to the normal drive 121 concentratedly while the normal drive 121 is in operation as in the first embodiment, and thus the operation time of the normal drive 121 can be cut short.

The second embodiment, in which only one RAID group is provided to write host data in temporarily, has an additional effect of needing less disk capacity for the log drive 122.

### Third Embodiment

A third embodiment of this invention will be described next.

The third embodiment differs from the above-described first and second embodiments in that data is temporarily stored in a disk cache 123. Unlike the normal disk 121 which is operated only when needed for data read/write and accordingly operates intermittently, the disk cache 123 is kept operating.

Differences between the disk cache 123 of the third embodiment and the log drive 122 of the first and second embodiments are as follows:

In the first embodiment, different write requests to write in the same logical block are stored in separate areas of the log drive 122. In the third embodiment, when there are different write requests to write in the same logical block, a hit check is conducted to check whether data of this logical block is stored in the disk cache 123 as is the case for normal cache memories. When data of this logical block is found in the disk cache 123, it is judged as a cache hit and the disk cache 123 operates the same way as normal cache memories do.

The disk cache 123 therefore divides a disk into segments and a disk cache segment management table 170 is stored in the cache memory 112. A segment of the disk cache 123 is designated out of the disk cache segment management table 170.

In the third embodiment, the same components as those in the first embodiment are denoted by the same reference symbols, and descriptions on such components will be omitted here.

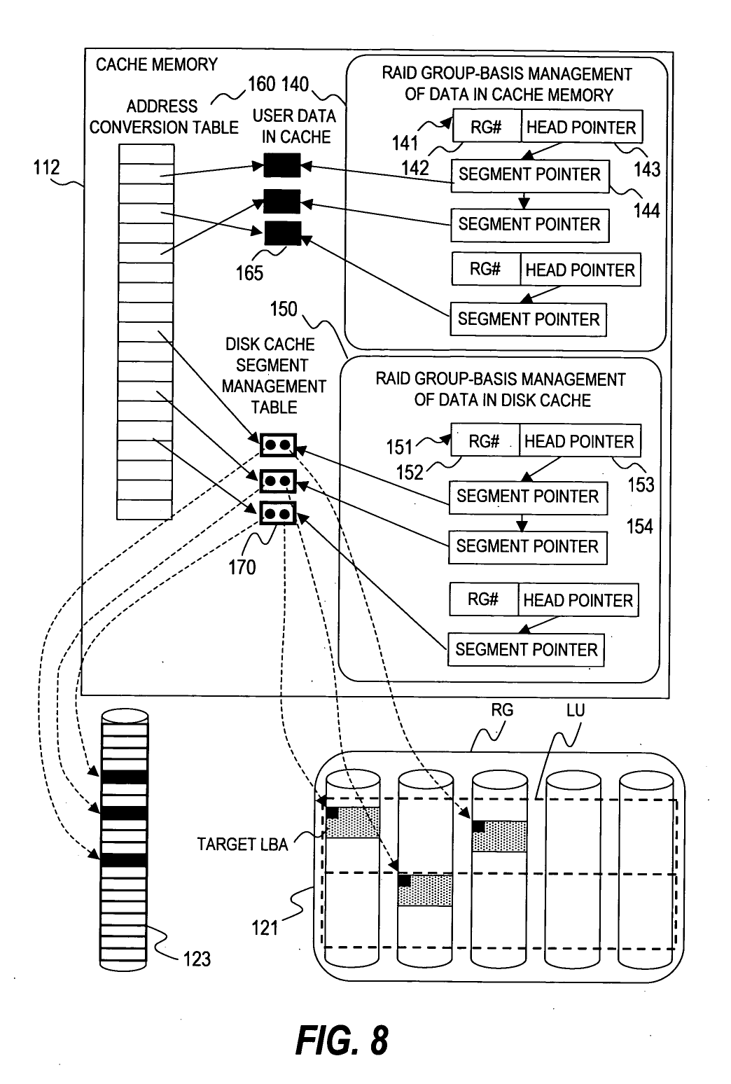

FIG. 8 is a configuration diagram of the cache memory 112 and the disk drives 120 in the disk array system 100 according to the third embodiment.

The disk drives 120 include a normal drive 121 and a disk cache 123.

The normal drive 121 constitutes a plurality of RAID group of a RAID 5. The normal drive 121 may constitute a RAID group of other RAID levels than RAID 5 (RAID 1 or RAID 4).

The disk cache 123 is a disk drive where host data sent from the host computer 200 is stored temporarily. The disk cache 123 may have a RAID configuration. The disk cache 123 is partitioned into segments of a fixed size (16 K bytes, for example).

The cache memory 112 stores a cache memory control table 140, a disk cache control table 150, an address conversion table 160, user data 165 and the disk cache segment management table 170.

The cache memory control table 140 is information used to manage for each RAID group data stored in the cache memory 112. The cache memory control table 140 contains RAID group number lists 141 each associated with a RAID group of the normal drive 121.

The RAID group number lists 141 have a linked-list format in which information on data stored in the cache memory 112 is sorted by RAID group of the normal drive 121. The RAID group number lists 141 each contain a RAID group number 142, a head pointer 143, and a segment pointer 144.

The RAID group number 142 indicates an identifier unique to each RAID group that the normal drive 121 builds. The head pointer 143 indicates, as information about a link to the first segment pointer 144 of the RAID group identified by the RAID group number 142, the address in the cache memory 112 at which the segment pointer 144 is stored. When this RAID group has no segment pointer 144, “NULL” is written as the head pointer 143.

The segment pointer 144 contains a number assigned to a segment of the cache memory 112 that stores data in question, and link information about a link to the next segment pointer.

The disk cache control table 150 is information used to manage for each RAID group data stored in the disk cache 123. The disk cache control table 150 contains RAID group number lists 151 each associated with a RAID group of the normal drive 121.

The RAID group number lists 151 have a linked-list format in which information on data stored in the disk cache 123 is sorted by RAID group of the normal drive 121. The RAID group number lists 151 each contain a RAID group number 152, a head pointer 153, and a segment pointer 154.

The RAID group number 152 indicates an identifier unique to each RAID group that the normal drive 121 builds. The head pointer 153 indicates, as information about a link to the first segment pointer 154 of the RAID group identified by the RAID group number 152, an address in the cache memory 112 at which the segment pointer 154 is stored. When this RAID group has no segment pointer 154, “NULL” is written as the head pointer 153.

The segment pointer 154 contains a number assigned to a segment of the cache memory 112 that stores an entry of the disk cache segment management table 170 for data in question, and link information about a link to the next segment pointer.

The address conversion table 160 is a hash table indicating whether or not the cache memory 121 and the disk cache 123 each have a segment that is associated with a logical unit number (LUN) and a logical block number (target LBA) that are respectively assigned to a logical unit and a logical block in which data is requested to be written by a data write request sent from the host computer 200. Looking up the address conversion table 160 with LUN and target LBA as keys produces a unique entry. In the address conversion table 160, a segment storing the user data 165 in the cache memory 112 and the segment management table 170 of the disk cache 123 are written such that one entry corresponds to one segment.

Alternatively, the address conversion table 160 may be written such that one entry corresponds to a plurality of segments. In this case, whether it is a cache hit or not is judged by checking LUN and target LBA respectively.

The user data 165 is data that is read out of the normal drive 121 and temporarily stored in the cache memory 112, or data that is temporarily stored in the cache memory 112 to be written in and returned to the normal drive 121.

The disk cache segment management table 170 is information indicating the association between data stored in the disk cache 123 and a location in the normal drive 121 where this data is to be stored. Details of the disk cache segment management table 170 will be described later.

The outline of host data storing operation will be described next.

The disk cache 123 of the disk array system 100 in the third embodiment is managed in the same way as the normal cache memory 112. To move host data stored in the disk cache 123 and host data stored in the cache memory 112 to the normal drive 121, the stored data is grouped by RAID group of the normal drive 121 so that host data is chosen for each RAID group, disks that constitute a RAID group in question are activated, and data chosen for this RAID group is moved to a corresponding logical block of the normal drive 121. This is achieved by obtaining the RAID group number list 141 that is associated with a RAID group in question and then following pointers to identify data of this RAID group.

When data of a logical block designated by a write request is found in the cache memory 112, the data is moved from the cache memory 112 to the normal drive 121 as in prior art.

When data of a logical block designated by a write request is found in the disk cache 123, the data is read out of the disk cache 123 and moved to the cache memory 112.

In the case where data of a logical block designated by a write request is not in the cache memory 112 but an entry for this logical block is found in the disk cache segment management table 170, it means that a disk cache segment has already been allocated. Then the data is stored in a segment of the disk cache 123 that is designated by the management table 170.

In the case where an entry for this logical block is not found in the disk cache segment management table 170, a segment of the disk cache 123 is newly secured and an entry for this logical block is added to the management table 170.

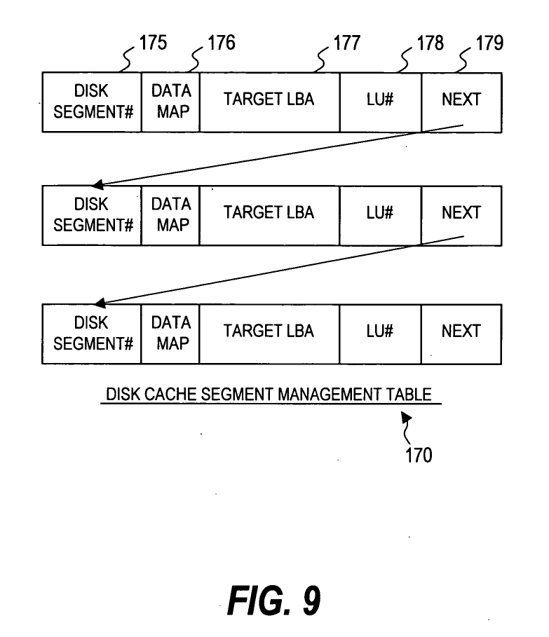

FIG. 9 is a configuration diagram of the disk cache segment management table 170 according to the third embodiment.

The disk cache segment management table 170 contains a disk segment number 175, a data map 176, a target LBA 177, a logical unit number 178 and link information 179, which is information about a link to the next entry.

The disk segment number 175 indicates an identifier unique to a segment of the disk cache 123 that stores data.

The data map 176 is a bit map indicating the location of the data in the segment of the disk cache 123. For instance, when 512 bytes are expressed by 1 bit, a 16-K byte segment is mapped out on a 4-byte bit map.

The target LBA 177 indicates a logical block address that is contained in a data write request sent from the host computer 200 as the address of a logical block in the normal drive 121 in which data stored in the disk cache 123 is to be written.

The logical unit number 178 indicates an identifier that is contained in a data write request sent from the host computer 200 as an identifier unique to a logical unit in the normal drive 121 that is where data stored in the disk cache 123 is to be written.

The link information 179 indicates, as a link to the next entry, an address in the cache memory 112 at which the next entry is stored. When there is no entry next to the current entry, “NULL” is written as the link information 179.

A block in the disk cache 123 storing data is specified from the disk segment number 175 and the data map 176. A block in the normal drive 121 storing data is specified from the target LBA 177 and the logical unit number 178.

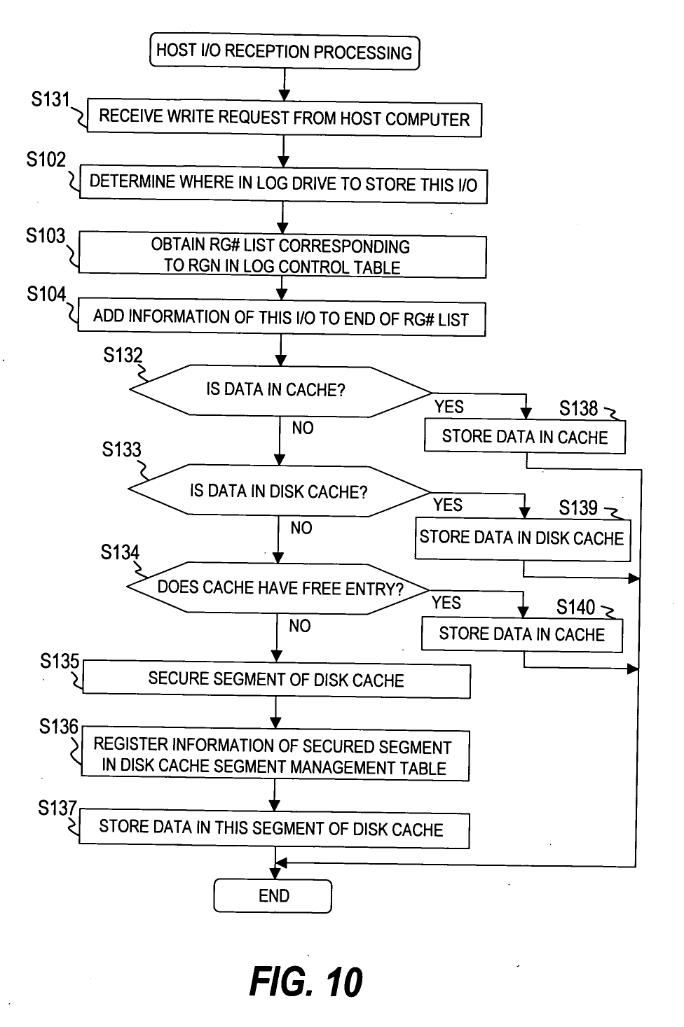

FIG. 10 is a flow chart for host I/O reception processing of the disk array system 100 according to the third embodiment. The host I/O reception processing is executed by the MPU 111 of the disk array controller 110.

First, a data write request is received from the host computer 200. The MPU 111 extracts from the received write request the logical unit number (LUN) of a logical unit in which data is requested to be written, the logical block number (target LBA) of a logical block in which the requested data is to be written, and the size of the data to be written. Then the MPU 111 identifies a number assigned to a RAID group to which the logical unit having the extracted logical unit number belongs (S131).

The MPU 111 then determines a position (source LBA) in the log drive 122 where the data requested to be written is stored (S102). Since write requests are stored in the log drive 122 in order, a logical unit that is next to the last logical unit where host data is stored is determined as the source LBA.

The MPU 111 next obtains the RAID group number list 131 that corresponds to the RAID group number identified in step S101. From the head pointer 133 of the obtained RAID group number list 131, the MPU 111 identifies a head address in the cache memory 112 at which the entry 134 of this RAID group is stored (S103).

Then the MPU 111 stores information of the write request in the RAID group number list 131. Specifically, the source LBA, target LBA, size, and logical unit number (LUN) according to the write request are added to the end of the RAID group number list 131 (S104).

Step S102 to step S104 of FIG. 10 are the same as step S102 to step S104 of FIG. 4 described in the first embodiment.

Thereafter, the address conversion table 160 is referred, and it is judged whether or not data requested to be written by the write request is in the cache memory 112 (S132). Specifically, in the address conversion table 160 which is a hash table using LUN and LBA as keys, an entry is singled out by LUN and LBA. The entry contains the disk cache segment management table 170, and the MPU 111 judges whether or not an LUN and an LBA that are subjects of a cache hit check match an LUN and an LBA that are managed by the disk cache segment management table 170.

When it is found as a result that an LUN and an LBA that are subjects of a cache hit check match an LUN and an LBA that are managed by the disk cache segment management table 170, it means that the data requested to be written by the write request is in the cache memory 112. Accordingly, the data requested to be written by the write request is stored in the cache memory 112 (S138), and the host I/O processing is ended. On the other hand, when an LUN and an LBA that are subjects of a cache hit check do not match an LUN and an LBA that are managed by the disk cache segment management table 170, it means that data associated with a logical unit number and an LBA that are contained in the write request is not in the cache memory 112. The MPU 111 therefore moves to step S133.

In step S133, the disk cache segment management table 170 is referred, and it is judged whether or not the data requested to be written by the write request is in the disk cache 123 (S133). Specifically, the management table 170 is searched for an entry that has the same logical unit number 178 and target LBA 177 as those in the write request.

When data having the logical unit number and the LBA that are contained in the write request is found in the disk cache segment management table 170 as a result of the search, it means that the data requested to be written by the write request is in the disk cache 123. Accordingly, the MPU 111 stores the data requested to be written by the write request in the disk cache 123 (S139), and ends the host I/O processing. When data having the logical unit number and the LBA that are contained in the write request is not found in the disk cache segment management table 170, it means that the data requested to be written by the write request is not in the disk cache 123, and the MPU 111 moves to step S134.

In step S134, the disk cache segment management table 170 is referred, and it is judged whether or not the cache memory 112 has a free entry (S134). Specifically, the MPU 111 judges whether or not a free segment is found in the disk cache segment management table 170.

The disk cache segment management table 170 manages lists of all segments of the disk cache 123. Segments are classified into free segments, which are not in use, dirty segments, and clean segments. Different types of segment are managed with different queues.

A dirty segment is a segment storing data the latest version of which is stored only in the disk cache 123 (data stored in the disk cache has not been written in the normal drive 121). In a clean segment, data stored in the normal drive 121 is the same as data stored in the disk cache because, for example, data stored in the disk cache has already been written in the normal drive 121, or because data read out of the normal drive 121 is stored in the disk cache.

When a free segment is found in step S134, it means that the cache memory 112 has a free entry. Accordingly, the MPU 111 stores the data requested by the write request in the cache memory 112 (S140), and ends the host I/O processing. On the other hand, when a free segment is not found in step S134, which means that the cache memory 112 does not have a free entry, the MPU 111 moves to step S135.

In step S135, the disk cache segment management table 170 is referred, and an area (segment) of the disk cache 123 is secured to write the requested data in. Information of the secured segment is registered in the disk cache segment management table 170 (S136). Specifically, a necessary segment is picked out of free segments in the disk cache segment management table 170, and registered as a secured segment in the disk cache segment management table 170.

Thereafter, the data requested to be written by the write request is stored in this segment of the disk cache 123 (S137).

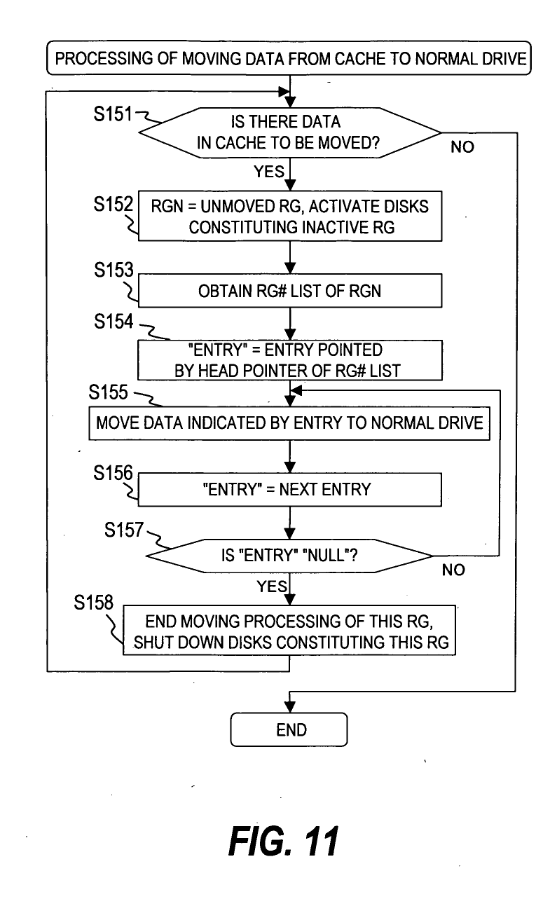

FIG. 11 is a flow chart for processing of moving data from the cache memory 112 to the normal drive 121 in the disk array system 100 according to the third embodiment. This data moving processing is executed by the MPU 111 of the disk array controller 110 when the amount of dirty data stored in the cache memory 112 exceeds a certain threshold, to thereby move data stored in the cache memory 112 to the normal drive 121. The threshold is set to, for example, 50% of the total storage capacity of the cache memory 112.

First, the MPU 111 refers to the cache memory control table 140 to judge whether or not data to be moved is in the cache memory 112 (S151). Specifically, the presence or absence of the segment pointer 144 is judged by whether or not “NULL” is written as the head pointer 143.

When the head pointer 143 is “NULL”, there is no segment pointer 144 and data to be moved is not in the cache memory 112. The MPU 111 accordingly ends this moving processing. On the other hand, when the head pointer 143 is not “NULL”, there is the segment pointer 144 and data to be moved is in the cache memory 112. The MPU 111 accordingly moves to step S152.

In step S152, a number assigned to a RAID group that has not finished moving data out is set to RGN. The MPU 111 activates disk drives constituting the RAID group that has not finished moving data out (S152). Thereafter, the MPU 111 obtains the RAID group number list 141 that corresponds to the set RGN (S153).

Referring to the obtained RAID group number list 141, the MPU 111 sets the first entry that is pointed by the head pointer 143 to “Entry” (S154).

The entry set to “Entry” is referred to move data indicated by “Entry” to the normal drive 121 (S155). Then the next entry is set to “Entry” (S156).

The MPU 111 judges whether or not the set “Entry” is “NULL” or not (S157).

When it is found as a result that “Entry” is not “NULL”, it means that there is an entry next to the current entry, and the MPU 111 returns to step S155 to move data indicated by the next entry.

On the other hand, when “Entry” is “NULL”, it means that there is no entry next to the current entry. The MPU 111 judges that the processing of moving data out of this RAID group has been completed, shuts down disk drives that constitute this RAID group, and returns to step S151 (S158) to judge whether there is an unmoved RAID group or not.

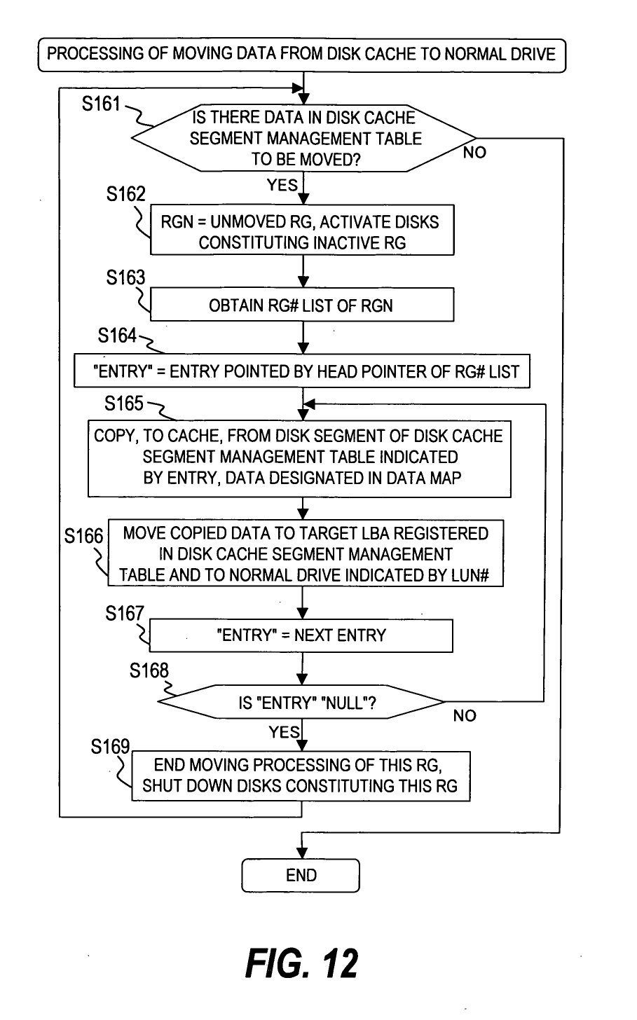

FIG. 12 is a flow chart for processing of moving data from the disk cache 123 to the normal drive 121 in the disk array system 100 according to the third embodiment. This data moving processing is executed by the MPU 111 of the disk array controller 110 when the amount of dirty data stored in the disk cache 123 exceeds a certain threshold, to thereby move data stored in the cache memory 112 to the normal drive 121. The threshold is set to, for example, 50% of the total storage capacity of the cache memory 112.

First, the MPU 111 refers the disk cache control table 150 and judges whether or not data to be moved is in the disk cache 123 (S161). Specifically, the presence or absence of the segment pointer 154 is judged by whether or not “NULL” is written as the head pointer 153.

When the head pointer 153 is “NULL”, there is no data to be moved in the disk cache 123. The MPU 111 accordingly ends this moving processing. On the other hand, when the head pointer 153 is not “NULL”, data to be moved is in the disk cache 123. The MPU 111 accordingly moves to step S162.

In step S162, a number assigned to a RAID group that has not finished moving data out is set to RGN. The MPU 111 activates disk drives constituting the RAID group that has not finished moving data out (S162). Thereafter, the MPU 111 obtains the RAID group number list 151 that corresponds to the set RGN (S163).

Referring to the obtained RAID group number list 151, the MPU 111 sets the first entry that is pointed by the head pointer 133 to “Entry” (S164).

The MPU 111 next copies, to the cache memory 112, data specified on a data map from a disk segment in the disk cache segment management table 170 that is indicated by “Entry” (S165). The copied data is moved to the normal drive 121 at a location specified by a target LBA and a logical unit number that are registered in the disk cache segment management table 170 (S166).

Then the next entry is set to “Entry” (S167).

The MPU 111 judges whether or not the set “Entry” is “NULL” or not (S168).

When it is found as a result that “Entry” is not “NULL”, it means that there is an entry next to the current entry, and the MPU 111 returns to step S165 to move, data indicated by the next entry.

On the other hand, when “Entry” is “NULL”, it means that there is no entry next to the current entry. The MPU 111 judges that the processing of moving data out of this RAID group has been completed, shuts down disk drives that constitute this RAID group, and returns to step S161 (S169) to judge whether there is an unmoved RAID group or not.

As has been described, in the third embodiment of this invention, data stored in the cache memory 112 is grouped by RAID group of the normal drive 121 to be moved to the normal drive 121 on a RAID group basis. The disk cache 123 which is kept operating is provided and data stored in the disk cache 123 is grouped by RAID group of the normal drive 121 to be moved to the normal drive 121 on a RAID group basis. The disk cache 123 can therefore be regarded as a large-capacity cache. In usual cases where a semiconductor memory cache which has a small capacity is used alone, data write from the cache to the normal drive 121 has to be frequent and the normal drive 121 is accessed frequently. In the third embodiment where the large-capacity disk cache 123 is provided, the normal drive 121 is accessed less frequently and the effect of this invention of reducing power consumption by selectively activating RAID groups of the normal drive 121 is exerted to the fullest.

In short, the third embodiment can reduce power consumption of the normal drive 121 even more since disks of the normal drive 121 which have been shut down are selectively activated when the disk cache 123 capable of storing a large amount of data is filled with data.

While the present invention has been described in detail and pictorially in the accompanying drawings, the present invention is not limited to such detail but covers various obvious modifications and equivalent arrangements, which fall within the purview of the appended claims.

What is claimed is:

1. A storage system, having an interface connected to a host computer, a controller connected to the interface and having a processor and a memory, and disk drives storing data that is requested to be written by the host computer;
wherein the storage system comprising: a log storage area for temporarily storing data that is requested to write by a write request sent from the host computer; and a plurality of data storage areas for storing the data requested to write by the write request,
wherein the controller provides the data storage areas as a plurality of RAID groups composed of the disk drives, and
wherein the controller moves data from the log storage area to the data storage areas on the RAID group basis.

2. The storage system according to claim 1,
wherein the controller operates at least one disk drive composing the log storage area in a manner that allows data write all the time, and
wherein the controller operates disk drives composing the data storage areas in a manner that normally prohibits data write but allows data write when data is moved from the log storage area to the data storage areas.

3. The storage system according to claim 1,
wherein the log storage area includes a first log storage area and a second log storage area in which data can be read and written independently of each other, and
wherein, the controller writes data that is requested to write by a write request sent from the host computer in the second log storage area while data is being moved from the first log storage area to the data storage areas.

4. The storage system according to claim 1,
wherein the controller receives a write request from the host computer and judges whether data stored in a block in one of the data storage areas that is specified by the received write request is in the log storage area or not, and
wherein, the controller stores the data requested by the received write request in the same block in the log storage area when data stored in the block in one of the data storage areas that is specified by the received write request is in the log storage area.

5. The storage system according to claim 1,
wherein the controller stores log control information, which indicates relation between data storing blocks in the log storage area and data storing blocks in the data storage areas, and
wherein the controller identifies a RAID group including data storage area related to data stored in the log storage area, based on the log control information.

6. The storage system according to claim 5, wherein the log control information is recorded with classified into each of the RAID groups.

7. A storage system, having an interface connected to a host computer, a controller connected to the interface and having a processor and a memory; and disk drives storing data that is requested to be written by the host computer;
wherein the storage system comprising: a log storage area for temporarily storing data that is requested to write by a write request sent from the host computer; and a plurality of data storage area for storing the data requested to write by the write request,
wherein the controller operates at least one disk drive composing the log storage area in a manner that allows data write all the time, and disk drives composing the data storage areas in a manner that normally prohibits data write but allows data write when data is moved from the log storage area to the data storage areas.

8. The storage system according to claim 7,
wherein the log storage area includes a first log storage area and a second log storage area in which data can be read and written independently of each other, and
wherein, while data is being moved from the first log storage area to the data storage areas, the controller writes data that is requested to write by a write request sent from the host computer in the second log storage area.

9. The storage system according to claim 7,
wherein the controller receives a write request from the host computer and judges whether data stored in a block in one of the data storage areas that is specified by the received write request is in the log storage area or not, and
wherein, the controller stores the data requested by the received write request in the same block in the log storage area when data stored in the block in one of the data storage areas that is specified by the received write request is in the log storage area.

10. The storage system according to claim 7,
wherein the controller stores log control information, which indicates relation between data storing blocks in the log storage area and data storing blocks in the data storage areas, and
wherein the controller identifies a data storing block in one of the data storage areas related to data stored in the log storage area, based on the log control information.

11. A method of controlling disk drives in a storage system that has an interface, which is connected to a host computer, a controller, which is connected to the interface and has a processor and a memory, and disk drives, which store data requested to be written by the host computer, the storage system further having a log storage area for temporarily storing data that is requested to write by a write request sent from the host computer and a plurality of data storage areas for storing the data requested to write by the write request, the controller providing the data storage areas as a plurality of RAID groups composed of the disk drives, the method comprising the steps of:
identifying RAID group which includes data storage area related to data stored in the log storage area; and
moving data from the log storage area to the data storage areas on the identified RAID group basis.

12. The method of controlling disk drives according to claim 11, further comprising the steps of:
operating at least one disk drive composing the log storage area in a manner that allows data write all the time; and
operating disk drives composing the data storage areas in a manner that normally prohibits data write but allows data write when data is moved from the log storage area to the data storage areas.

13. The method of controlling disk drives according to claim 11,
wherein the log storage area includes a first log storage area and a second log storage area in which data can be read and written independently of each other, and
wherein the method of controlling disks further comprises the step of, writing data that is requested to write by a write request sent from the host computer in the second log storage area while data is being moved from the first log storage area to the data storage areas.

14. The method of controlling disk drives according to claim 11, further comprising the steps of:
receiving a write request from the host computer;
judging whether data stored in a block in one of the data storage areas that is specified by the received write request is in the log storage area or not; and
storing the data requested by the received write request in the same block in the log storage area when data stored in the block in one of the data storage areas that is specified by the received write request is in the log storage area.

15. The method of controlling disk drives according to claim 11, further comprising the steps of:
storing log control information, which indicates relation between data storing blocks in the log storage area and data storing blocks in the data storage areas, and
identifying a RAID group including data storage area related to data stored in the log storage area, based on the log control information.

16. The method of controlling disks according to claim 15, further comprising the steps of recording the log control information with classified into each of the RAID groups.
